(19) United States
(12) Patent Application Publication
(10) Pub. No.: US 2006/0061200 A1
(43) Pub. Date: Mar. 23, 2006

(54) Mounting device for an infant's safety chair

(76) Inventor: Huang-Kuo Liao, Tali City (TW)

Correspondence Address: HERSHKOVITZ & ASSOCIATES, 1725 I STREET NW, SUITE 300, WASHINGTON, DC, 20006, US

(21) Appl. No.: 10/896,987

(22) Filed: Jul. 23, 2004

(51) Int. Cl. B60R 22/12

(52) U.S. Cl. 297/468

(57) ABSTRACT

A mounting device for an infant's safety chair has an attaching bracket and a fastening belt. The fastening belt is secured on the attaching bracket, is adjustable in length and has a distal end and an insert attached to the distal end. The insert is adapted to insert into a seam between a floor of the car and a bottom face of a seat body on an adult seat inside a vehicle to firmly combine the infant's safety chair to the adult seat. Moreover, a hook is formed on the insert to engage any proper place under the adult seat. Selectively, two mounting devices are respectively attached under the adult seat and then engage with each other to loop the seat body of the adult seat. Thereby, the infant's safety chair is enabled to selectively attach to an adult seat without seam for receiving the insert.

### BACKGROUND OF THE INVENTION

1. Field of the Invention

The present invention relates to a mounting device, and more particularly to a mounting device for holding an infant's safety chair conveniently and stably inside a vehicle.

2. Description of Related Art

When an infant is seated in a vehicle, an infant's safety chair is important to keep the infant safe from being thrown around by the motion of the vehicle. Arrangement of the infant's safety chair is divided into two types, one is “forward facing” and the other is “backward facing”. The “forward facing” arrangement is to place the chair in the-same orientation with an original adult seat inside the vehicle so that the infant faces forward. The “backward facing” arrangement is to place the chair in an opposite orientation with the original adult seat to make the infant face backward. The “backward facing” arrangement is preferred because the infant, particularly its face, can be easily observed by someone sitting adjacent the safety chair.

A conventional infant's safety chair for the “forward facing” arrangement is shown in FIG. 7, which is mounted on an adult seat (60) inside the vehicle. The conventional infant's safety chair comprises a base (53) and a chair (50) composed of a backrest (52) and a seat body (51). The base (53) is attached under the seat body (51) and is directly placed on a seat body (61) of the adult seat (60). The backrest (52) has a through hole (522) defined near joint between the backrest (52) and the seat body (51). Only one securing means is applied to the conventional infant's safety chair, a seat belt (63) of the adult seat (60) is pulled forward and then penetrates the through hole (522) to detachably attach with a buckle (not shown). Therefore, the infant's safety chair (50) is combined with the adult seat (60).

However, the conventional infant's safety chair easily swings, vibrates or inclines to the front of the car when the vehicle is subjected to emergency braking because the seat belt (63) can not tie the infant's safety chair firmly to the adult seat of the car. Those dangerous situations may frighten the infant or even result in neck injuries to the vulnerable infant.

The present invention has arisen to mitigate or obviate the drawbacks of the conventional infant's safety chair.

### SUMMARY OF THE INVENTION

The main objective of the present invention is to provide a mounting device for an infant's safety chair that stably holds the infant's safety chair on an adult seat in a vehicle.

Further benefits and advantages of the present invention will become apparent after a careful reading of the detailed description with appropriate reference to the accompanying drawings.

### BRIEF DESCRIPTION OF THE DRAWINGS

FIG. 1 is a side plane view of a mounting device for an infant's safety chair in accordance with the present invention, wherein the mounting device is attached under a conventional infant's safety chair in accordance with the prior art;

FIG. 2 is a perspective bottom view of the mounting device that substantially comprises a bracket and a belt;

FIG. 3 is an enlarged perspective view of the belt and other accessories attached to the belt in FIG. 2;

FIG. 4 is an operational cross-sectional side view of adjusting the belt in FIG. 3;

FIG. 5 is an operationally side view of a first embodiment of the mounting device for an infant's safety chair, wherein the infant's safety chair is facing backward;

FIG. 6 is an operationally side view of a second embodiment of the mounting device for an infant's safety chair, wherein the mounting device has two belts engaging with each other; and

FIG. 7 is a side view of the conventional infant's safety chair in accordance with the prior art.

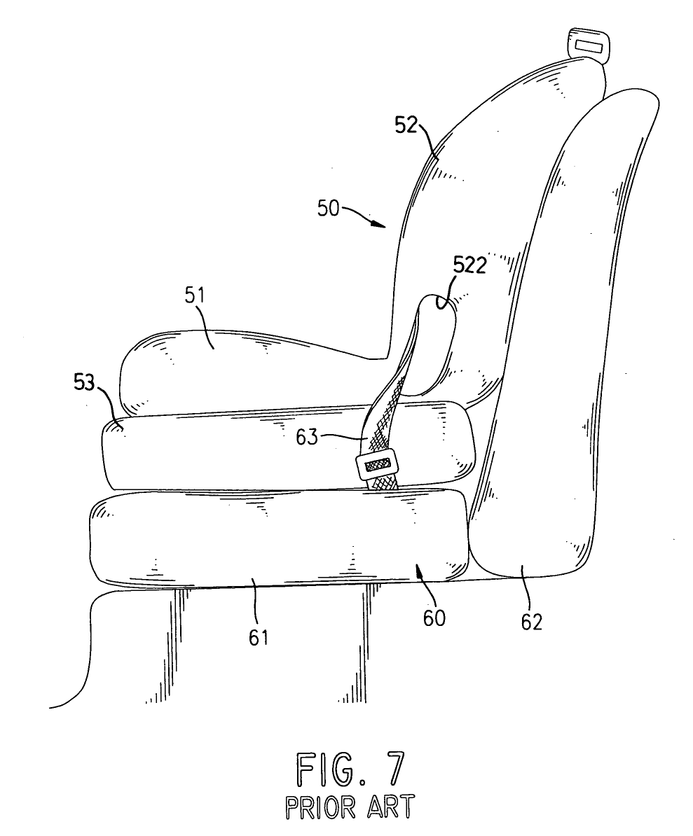

### DETAILED DESCRIPTION OF THE PREFERRED EMBODIMENT

A mounting device for an infant's safety chair in accordance with the present invention comprises an attaching bracket and a fastening belt. The fastening belt is secured on the attaching bracket, is adjustable in length and has a distal end and an insert attached to the distal end. The insert is adapted to insert into a seam between a floor of the car and a bottom face of a seat body on an adult seat inside a vehicle to firmly combine the infant's safety chair to the adult seat. Moreover, a hook is formed on the insert to engage with any proper place under the adult seat. Selectively, two mounting devices are respectively attached under the adult seat at a front end and a rear end and then engage with each other by means of the hooks to loop the seat body of the adult seat. Thereby, the infant's safety chair is enabled to selectively attach to a front adultseat in the vehicle because the front adult seat is not closely mounted on the floor of the vehicle and this particular adult seat has no seam for receiving the insert.

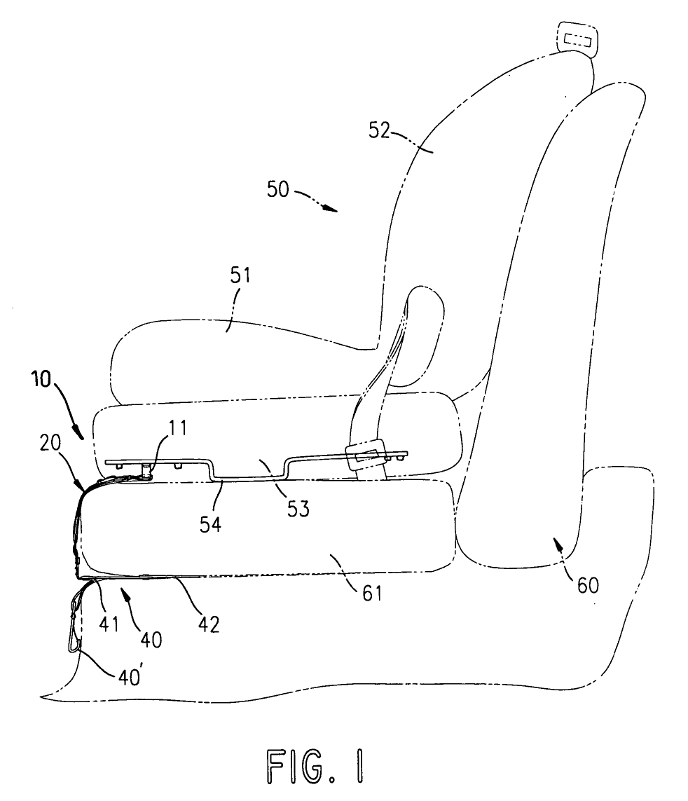

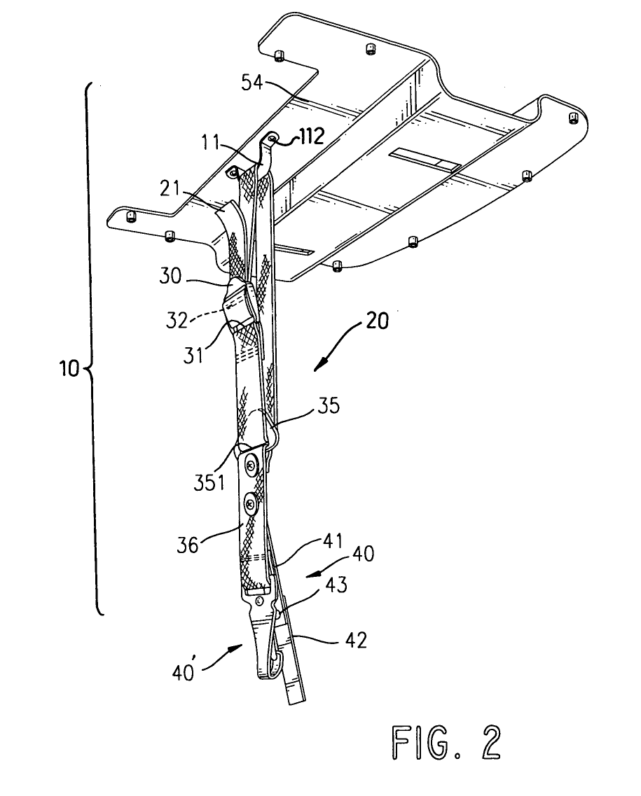

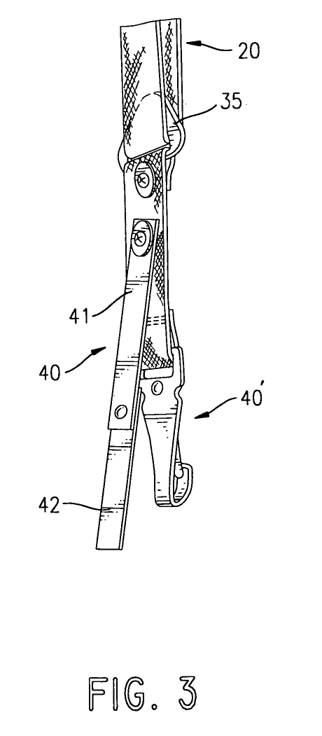

With reference to FIGS. 1 to 3, a preferred embodiment of the mounting device (10) for an infant's safety chair in accordance with the present invention comprises substantially an attaching bracket (11) and a fastening belt (20) and an optional bottom plate (54). The infant's safety chair (50) comprises a base (53), a backrest (52) and a seat body (51).

The optional bottom plate (54) is adapted to secure under the infant's safety seat and has a front end and a rear end. The attaching bracket (11) is U-shaped frame with two distal ends (112) firmly attached on the bottom plate (54) by means of screws. Selectively, the attaching bracket (11) is enabled to directly attach to the base (53) of the infant's safety chair (50).

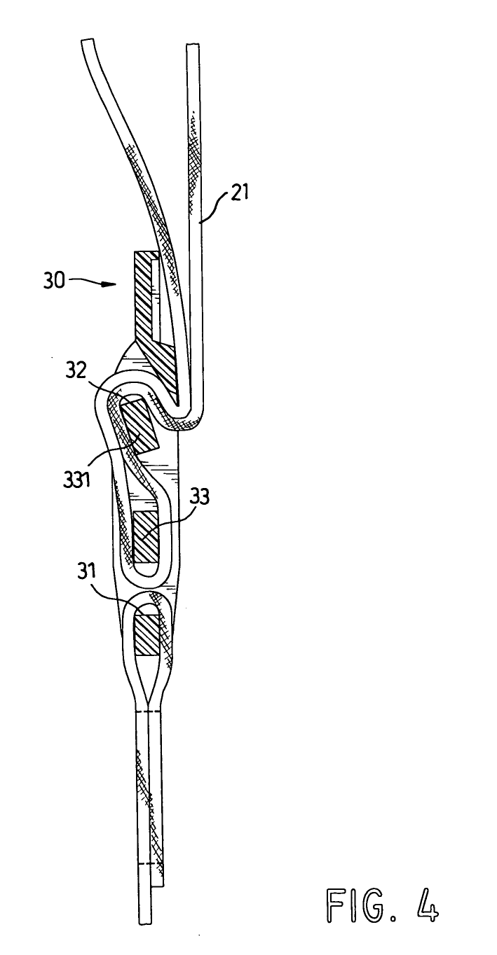

The fastening belt (20) attached to the attaching bracket (11) is composed of a first strip (21), a second strip (36), an optional adjusting buckle (30), an optional engaging ring (35) and an insert (40). The optional engaging ring (35) is a triangular plate and has a bottom edge and a strip hole (351) defined through the triangular plate near and parallel to the bottom edge. With further reference to FIG. 4, the optional adjusting buckle (30) is an annular ring having a first rod (33) and a second rod (331) so as to define a first hole (31), a middle hole and a second hole (32) within the adjusting buckle (30).

As shown in FIG. 4, the first strip (21) has an attached end and a free end. The attached end penetrates between the U-shaped attaching bracket ( 11) and the bottom plate (54), goes through the strip hole (351) on the engaging ring (35), and is lastly attached to the adjusting buckle (30). The free end extends to adjustably combine with the adjusting buckle (30) to form a loop. On the adjusting buckle (30), the free end of the first strip (21) penetrates the second hole (32) to one side of the adjusting buckle (30), extends through the middle hole to the other side of the adjusting buckle (30), and then penetrates the first hole (31) to loop the first rod (33) to form a winding path. Lastly, the free end of the first strip (21) overlaps an earlier part of the first strip (21) at the second rod (331) and reverses the winding path to extend out of the adjusting buckle (30). Thereby, the free end of the first strip (21) can be further drawn out or retracted back into the loop of the first strip (21) to adjust a length of the fastening belt (20).

The second strip (36) attached to the engaging ring (35) has two ends, one end looping on the engaging ring (35) via the strip hole (351) and the other end combining with the insert (40).

The insert (40) is a long rigid strip composed of a first section (41) and a second section (42). The first section (41) and the second section (42) are pivotally combined with each other so that the insert (40) is sufficiently long to provide a further positioning effect to the infant's safety chair when the insert (40) is inserted into a seam between a floor of the car and a bottom face of a seat body (61) on an adult seat (60) inside a vehicle.

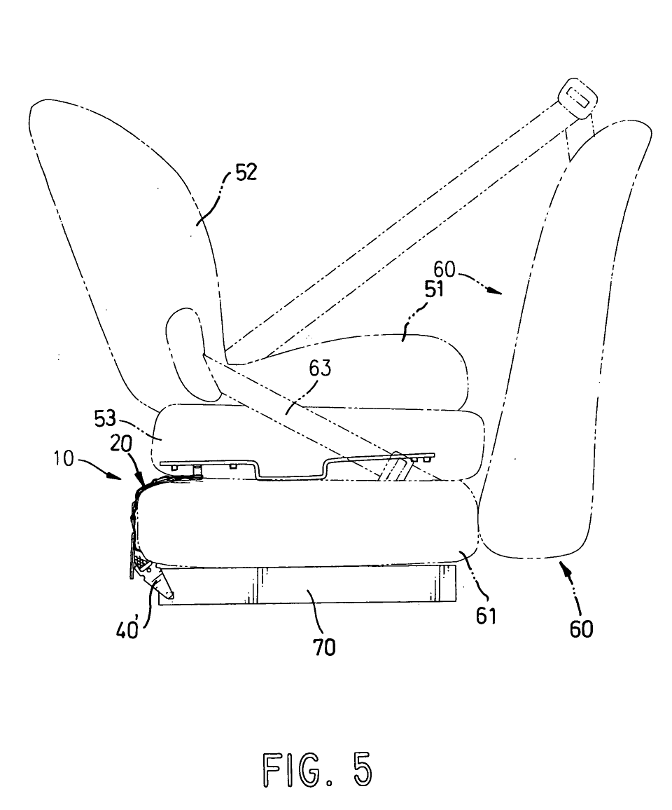

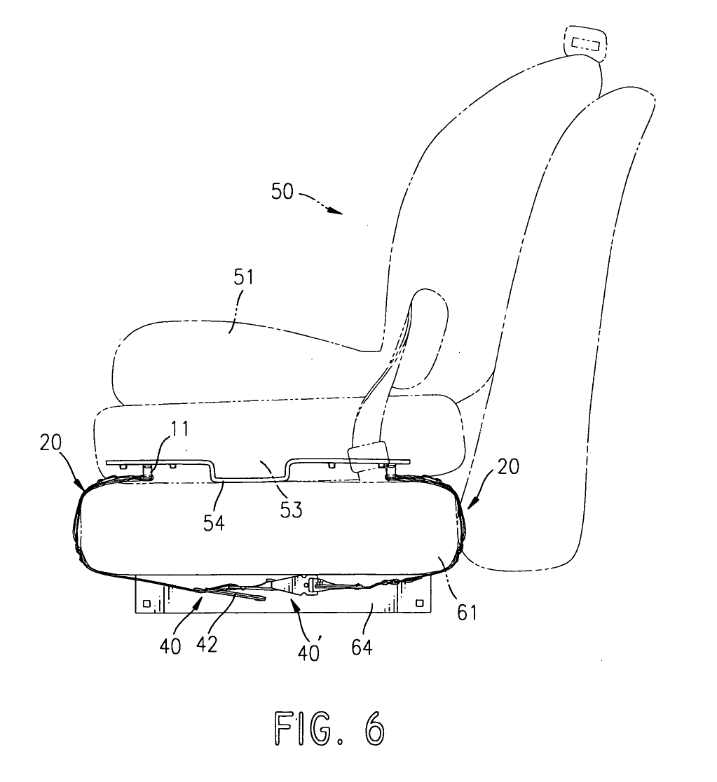

Additionally, with further reference to FIG. 5, a hook (40′) is further attached to the distal end of the fastening belt (20) to allow the mounting device to hook on any proper place (such as a track (70) shown in FIG. 5) under the seat body (61) of the adult seat (60). With reference to FIG. 6, as for some adult seats that lack the seam for receiving the insert, two mounting devices are operationally attached under the bottom plate (54) respectively at the front end and the rear end. Then, the two fastening belts (20) extend to under the seat body (61) to hook with each other by hooks. Thereby, the infant's safety chair still can be firmly mounted on the adult seat (60) without there being the seam for receiving the insert.

According to the above description, the mounting device for an infant's safety chair of the present invention has the following advantages:
1. The mounting device attached under the infant's safety chair provides a sufficient holding efficiency so that the infant's seat is enabled to keep steady whereby the infant sitting inside is comfortable and safe.
2. The mounting device for an infant's safety chair in the present invention is convenient in attachment. Moreover, the length of the fastening belt (20) can be adjusted to operationally match different adult seats.

Although the invention has been explained in relation to multiple preferred embodiments, many other possible modifications and variations can be made without departing from the spirit and scope of the invention as hereinafter claimed.

What is claimed is:

1. A mounting device for an infant's safety chair comprising:
an attaching bracket (11) adapted to attach under the infant's safety chair;
a fastening belt (20) attached under the attaching bracket (11) and comprising
a first strip (21) forming a loop on the attaching bracket (11) and having an attached end and a free end; and
a second strip (36) connected to the first strip (21) and has a distal end; and
an insert (40) attached to the distal end of the second strip (36) and composed of a first section (41) and a second section (42) pivotally connected with each other.

2. The mounting device as claimed in claim 1, wherein the mounting device (10) further has a bottom plate (54) adapted to attach under the infant's safety chair and being attached by the attaching bracket (11).

3. The mounting device as claim in claim 1, wherein the fastening belt (20) further has:
an engaging ring (35) having a strip hole (351) defined through the engaging ring (35); and
an adjusting buckle (30) being an annular ring having a first rod (33) and a second rod (331) within the annular ring to define a first hole (31), a middle hole and a second hole (32) within the adjusting buckle (30);
wherein, the attached end of the first strip (21) secured on the adjusting buckle (35) and the free end of the first strip (21) penetrates through the strip hole (351) of the engaging ring (35), extends to loop on the adjusting buckle (35) around the first rod (33) and second rod (331) via the first hole (31), middle hole, and second hole (32), and further extends out of the adjusting buckle (30);
wherein, the second strip (36) penetrates the strip hole (351) to loop on the engaging ring (351) to connect to the first strip (21).

4. The mounting device as claim in claim 2, wherein the fastening belt (20) further has:
an engaging ring (35) having a strip hole (351) defined through the engaging ring (35); and
an adjusting buckle (30) being an annular ring having a first rod (33) and a second rod (331) within the annular ring to define a first hole (31), a middle hole and a second hole (32) within the adjusting buckle (30);
wherein, the free end of the first strip (21) penetrates through the strip hole (351) of the engaging ring (35), extends to loop on the adjusting buckle (35) around the first rod (33) and second rod (331) via the first hole (31), middle hole, and second hole (32), and further extends out of the adjusting buckle (30);
wherein, the second strip (36) penetrates the strip hole (351) to loop on the engaging ring (351) to connect to the first strip (21).

5. The mounting device as claim in claim 1, wherein the fastening belt (20) further has a hook (40′) attached to the distal end of the second strip (36).

6. The mounting device as claim in claim 2, wherein the fastening belt (20) further has a hook (40′) attached to the distal end of the second strip (36).

7. The mounting device as claim in claim 4, wherein the fastening belt (20) further has a hook (40′) attached to the distal end of the second strip (36).

8. A mounting device for an infant's safety chair comprising:
a bottom plate (54) adapted to attach under the infant's safety chair;
at least two attaching brackets (11) attached to the bottom plate (54);
at least two fastening belts (20) respectively attached to the at least two attaching brackets (11) one for one, each fastening belt (20) comprising:
a first strip (21) forming a loop on the attaching bracket (11) and having an attached end and a free end; and
a second strip (36) connected to the first strip (21) and having a distal end; and
an insert (40) attached to the distal end of the second strip (36) and composed of a first section (41) and a second section (42) pivotally connected with each other.

9. The mounting device as claim in claim 8, wherein each fastening belt (20) further has:
an engaging ring (35) having a strip hole (351) defined through the engaging ring (35); and
an adjusting buckle (30) being an annular ring having a first rod (33) and a second rod (331) within the annular ring to define a first hole (31), a middle hole and a second hole (32) within the adjusting buckle (30);
wherein, the attached end of the first strip (21) secured on the adjusting buckle (35) and the free end of the first strip (21) penetrates through the strip hole (351) of the engaging ring (35), extends to loop on the adjusting buckle (35) around the first rod (33) and second rod (331) via the first hole (31), middle hole, and second hole (32), and further extends out of the adjusting buckle (30);
wherein, the second strip (36) penetrates the strip hole (351) to loop on the engaging ring (351) to connect to the first strip (21).

10. The mounting device as claim in claim 9, wherein each fastening belt (20) further has a hook (40′) attached to the distal end of the second strip.
